(19) United States
(12) Patent Application Publication
(10) Pub. No.: US 2007/0230845 A1
(43) Pub. Date: Oct. 4, 2007

(54) Bearing element

(76) Inventor: Thomas Rumpf, Gmunden (AT)

Correspondence Address: WILLIAM COLLARD;COLLARD & ROE, P.C., 1077 NORTHERN BOULEVARD, ROSLYN, NY, 11576, US

(21) Appl. No.: 11/728,988

(22) Filed: Mar. 27, 2007

(30) Foreign Application Priority Data
Mar. 30, 2006 (AT) A 550/2006

(51) Int. Cl. F16C 33/02

(52) U.S. Cl. 384/276

(57) ABSTRACT

The invention describes a lining made from an alloy with a silver or copper base for a bearing element. Silver or copper form the matrix including impurities that are unavoidable from the production of these metals and bismuth is contained in an amount selected from a range with a lower limit of 2 wt. % in the case of silver or 0.5 wt. % in the case of copper and with an upper limit for both of 49 wt. %.

### CROSS REFERENCE TO RELATED APPLICATIONS

Applicant claims priority under 35 U.S.C. §119 of AUSTRIAN Patent Application No. A 550/2006 filed on Mar. 30, 2006.

### BACKGROUND OF THE INVENTION

1. Field of the invention

The invention relates to a lining made from an alloy with a silver or copper base for a bearing element and a bearing element provided therewith comprising a support element, the lining and a bearing metal layer arranged in between.

2. Prior Art

Sliding bearings are characterized partly in that they have a relatively soft lining in order to allow for adjustment to the supported element, for example a shaft, and to a certain degree to enable foreign particles to become embedded. In order to provide these tribological properties so far mainly linings containing tin or lead have been proposed in the prior art. However, lead is undesirable due to its toxicity and, particularly recently, increasing attempts have been made to find ways of eliminating lead.

For highly stressed sliding bearings suitable for use in lorries new lining systems have been proposed, such as e.g. SnCu6/NiSn/Ni-layers or layers made purely of bismuth or from a bismuth alloy, in which the bismuth forms the matrix. The latter linings are known from DE 100 32 624 A and DE 10 2004 015 827 A. Said bismuth linings are characterized by the specific orientation of the crystallites.

From the prior art copper based alloys are also known that contain bismuth. Thus GB 2 355 016 A describes a copper alloy which contains 0.5 wt. % to 15 wt. % tin, 1 wt. % to 20 wt. % bismuth and 0.1 vol. % to 10 vol. % hard particles which have an average diameter of 1 to 45 μm. The bismuth is dispersed in the alloy. The hard particles can be borides, silicides, oxides, nitrides, carbides and/or intermetallic phases. The alloy can also contain iron, aluminium, zinc, manganese, cobalt, nickel, silicon and/or phosphorus in an amount of not more than 40 wt. %. To improve the sliding properties up to 20 vol. % can be MoS₂, WS₂, BN and/or graphite. The alloy is produced by powder metallurgy and used for bushings or pressure pads.

However, for all of these known linings it can be observed that they do not sufficiently withstand the increasing stresses of sliding bearings and do not satisfy other requirements, such as e.g. low toxicity etc.

### SUMMARY OF THE INVENTION

The objective of the invention is to provide a lead-free lining and a corresponding bearing element.

Said objective of the invention is achieved independently by the lining according to the invention in which silver or copper form the matrix, including the impurities that are unavoidable from the production of these metals, and bismuth is contained in an amount selected from a range with a lower limit of 2 wt. % in the case of silver or 0.5 wt. % in the case of copper and an upper limit for both of 49 wt. %, or by a bearing element which contains the lining according to the invention.

In a surprising manner it has been established that in the binary alloys of silver and bismuth or copper and bismuth, the bismuth not only takes over the task of the soft phase, which is responsible for the embedding ability of the lining, but bismuth also contributes to the increase in wearing resistance. In this way, similarly good properties are obtained, as with lead bronzes which have been used in the prior art for these purposes.

The lower limit for the proportion of bismuth with 2 wt. % in the case of silver or 0.5 wt. % in the case of copper was selected so that below this amount in the binary alloys bismuth is present as a mixed crystal with silver or copper, so that there is no dispersion in the matrix made of silver or copper. However, it should be noted that these limits are based on the data currently available from phase diagrams, wherein said phase diagrams contain certain inaccuracies due to measurement techniques, so that also amounts of bismuth in the alloy slightly below these limits are covered by the scope of protection, as long as there is also a dispersed bismuth phase in the alloy.

According to one embodiment variant the bismuth content is selected from a range with a lower limit of 10 wt. % and an upper limit of 30 wt. %. In this way the tribology of the lining is improved in that the brittleness of the alloy is reduced, the ability to embed foreign particles and the sliding property is improved as well as the prevention of friction welding of the alloy. The lining is thus suitable for higher levels of stress.

In order to improve the wearing properties it is possible for hard particles to be included in the binary alloy with a particle size selected from a range with a lower limit of 10 nm and an upper limit of 100 nm. By means of these so-called nanoparticles the sliding property is not influenced negatively so that the surface of the lining has no interfering hard points etc. Furthermore, these particles are preferably present in the dispersed bismuth phase, whereby with higher proportions of bismuth in the alloy the risk of fracture at the particle boundaries is reduced.

Said nanoparticles can be selected from a group comprising oxides, carbides, nitrides, such as e.g. titanium dioxide, zirconium dioxide, aluminium oxide, tungsten carbide, silicon nitride and also diamond and mixtures of at least two different materials, as these particles are also characterized by having a high level of hardness.

It is also an advantage if the proportion of nanoparticles, relative to the binary alloy of silver and bismuth or copper and bismuth, is selected from a range with a lower limit of 0.05 vol. % and an upper limit of 5 vol. %, as these particles are distributed in this proportion at least largely due to the lower melting point of bismuth in the bismuth phase, and thus increase the structural strength of the lining. The hard particles coexist with the bismuth phase. In particular, it is an advantage if the proportion of nanoparticles is selected from a range with a lower limit of 0.5 vol. % and an upper limit of 3 vol. % or from a range with a lower limit of 1 vol. % and an upper limit of 2.5 vol. %. For example, the proportion can be 0.1 vol. % or 0.9 vol. % or 1.5 vol. % or 2 vol. % or 3.5 vol. % or 4 vol. % or 4.5 vol. %.

### BRIEF DESCRIPTION OF THE DRAWINGS

For a better understanding of the invention the latter is explained in more detail with reference to the following examples.

FIG. 1 shows the wearability of various linings.

### DETAILED DESCRIPTION OF PREFERRED EMBODIMENTS

Firstly, it should be noted that the details on position used in the description, such as e.g. top, bottom, side etc. relate to the embodiment variant being described at the time and if there is a change in position should be transposed to the new position. Furthermore, individual features or combinations of features from the various embodiments described can represent in themselves independent solutions according to the invention.

The bearing element according to the invention consists of a support element, a lining and a bearing metal layer arranged between the support element and the lining.

The support element is usually made of steel or a comparable material and gives the bearing element the required strength.

The bearing metal layer can be any known bearing metal layer, for example an aluminium-tin alloy, a copper alloy or an aluminium alloy etc.

Possible examples are:
1. Bearing metals with an aluminium base (according to DIN ISO 4381 or 4383):

ALSn6CuNi, AlSn20Cu, AlSi4Cd, AlCd3CuNi, AlSi11Cu, AlSn6Cu, AlSn40, AlSn25CuMn, AlSi11CuMgNi;
2. Bearing metals with a copper base (according to DIN ISO 4383): CuSn10, CuAl10Fe5Ni5, CuZn31Si1, CuPb24Sn2, CuSn8Bi10;
3. Bearing metals with a tin base: SnSb8Cu4, SnSb12Cu6Pb.

Of course, other layers than the known bearing metals can be used with a base of aluminium, nickel, copper, silver, tin, iron or chromium.

If necessary, there can be at least one further layer between the lining and the bearing metal layer and/or the bearing metal layer and the support element. The latter can act for example as a diffusion barrier or as a bonding layer. It is possible to use e.g. Al, Mn, Ni, Fe, Cr, Co, Cu, Ag, Mo, Pd and NiSn or CuSn alloys for such layers.

The bearing element according to the invention is defined in particular as a lining. This can be in the form of a half bearing shell for example, whereby for the bearing itself two half bearing shells can be put together in a known manner. On the other hand, it is also possible for the bearing element to be a bearing bush or a thrust ring etc. Furthermore, it is possible for the lining to be applied directly onto an element of a bearing component group, for example into the eye of a connecting rod. The lining according to the invention consists of a binary alloy with a silver or copper matrix in which bismuth is dispersed. The following samples were prepared of the lining representing alloys from the entire range of bismuth content claimed.

TABLE 1

| Number | Ag [wt. %] | Bi [wt. %] |
|---|---|---|
| 1 | 99 | 1 |
| 2 | 95 | 5 |
| 3 | 90 | 10 |
| 4 | 88 | 12 |
| 5 | 82 | 18 |
| 6 | 75 | 25 |
| 7 | 70 | 30 |
| 8 | 65 | 35 |
| 9 | 60 | 40 |
| 10 | 52 | 48 |

TABLE 2

| Number | Cu [wt. %] | Bismuth [wt. %] |
|---|---|---|
| 11 | 98 | 2 |
| 12 | 97 | 7 |
| 13 | 90 | 10 |
| 14 | 85 | 15 |
| 15 | 78 | 22 |
| 16 | 70 | 30 |
| 17 | 65 | 35 |
| 18 | 60 | 40 |
| 19 | 56 | 54 |
| 20 | 51 | 49 |

The lining according to the invention was applied galvanically to a semi-finished product. Said semi-finished product was produced by plating the bearing metal layer onto the support element.

As the electrochemical potential of the layer components silver or copper and bismuth with a suitable complexing are relatively close to one another, it is possible with a weak complex formation to formulate a stable electrolyte. The two following electrolytes are seen as an alternative.

Electrolyte 1:

| | |
|---|---|
| Silver as KAg(CN₂) | 22 g/l. |
| Bismuth BiO(NO₃)•H₂O | 7 g/l. |
| KOH | 35 g/l |
| KNaC₄H₄O₆•4H₂O | 60 g/l |
| Tenside | 0.1 g/l |

The coating was carried out at a current density of 0.75 A/dm³ at a bath temperature of 25° C.

Electrolyte 2:

| | |
|---|---|
| Silver as methane sulphonate (MSA) | 30 g/l |
| Bismuth as methane sulphonate (MSA) | 7 g/l |
| Protein amino acid | 100 g/l |
| Tenside | 0.1 g/l |

The coating was carried out at a current density of 1 A/dm³ and at a temperature of 25° C.

Instead of the silver salts in the above electrolytes 1 and 2 copper salts can also be used, such as e.g. Cu methane sulphonate, Cu-fluoroborate, Cu-sulphate, Cu-pyrophosphate, Cu-phosphonate etc.

It should be noted at this point, that as well as galvanic coating roll cladding on the bearing metal layer of an already finished layer of the alloy according to the invention is possible. As this method is already known from the prior art persons skilled in the art are referred to the relevant literature.

Furthermore, it is possible to produce the lining by means of a PVD method. In particular, cathode sputtering is advantageous in this case. Here two cathodes can be used one made of silver or copper and the other of bismuth. It is also possible hereby to obtain a concentration gradient of bismuth inside the layer, in that the cathodes are operated at varying outputs throughout the coating procedure.

By means of such a gradient in the layer it is possible to design the lining in the region of the element to be supported, for example the shaft, with a high proportion of bismuth, so that the embedding ability and lubricating ability is improved in this area. In the region of the transition to the bearing metal layer the bismuth content in the alloy can be lower, whereby the lining according to the invention can have greater structural strength. For the method this means that at the beginning of the deposition the output of the bismuth cathode is at its lowest and is slowly increased—either stepwise or continually—during the coating up to an end value.

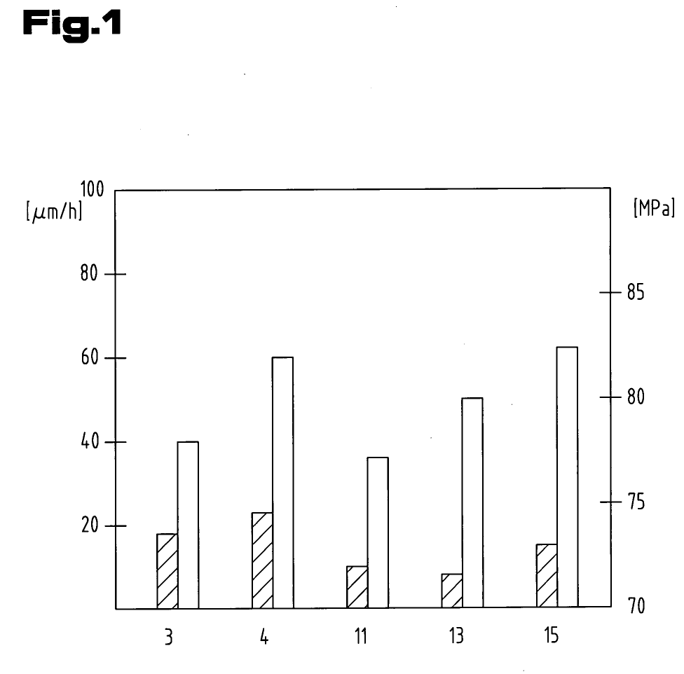

The results of the tests carried out on the samples 3, 4, 11, 13 and 15 are shown in FIG. 1 which are representative of all other samples. The number of respective samples is entered on the x-axis, the left y-axis denotes the wear rate in μm/h running time, the right y-axis the stress of corrosion of the lining in MPa. Correspondingly, the left bar shows the wear rate and the right bar the stress on the individual samples.

The tests were carried out with a lubricant oil of the SAE 10 type. The surface speed was 12.6 m/s. The layer thickness of the lining was 20 μm.

It should be mentioned at this point that the thickness of the lining can vary, whereby within the scope of the development layer thickness of in the region of 2 μm and 25 μm were produced and tested. Thus linings with a thickness of 4 μm, 8 μm, 12 μm, 15 μm, 20 μm and 25 μm were produced.

The hardness levels according to Vickers of the tested linings varied within the range of 65 HV to 170 HV. However, hardness levels selected from a range with a lower limit of HV 85 and an upper limit of HV 120 were also produced.

As shown in FIG. 1, all of the tested samples are comparable with respect to their stressability with the lead bronzes known from the prior art. With respect to corrosion it could established that alloys with a bismuth content, selected from a range with a lower limit of 10 wt. % and an upper limit of 30 wt. % did better.

As already mentioned, it is possible to improve the wearing resistance of the lining by incorporating nanoparticles. The latter can have a particle size selected from a range with a lower limit of 10 nm and an upper limit of 100 nm. Preferably, the lining is produced in such a way that the hard particles are embedded into the dispersed bismuth phase. The lining itself can be produced by melt metallurgy and joined for example by roll cladding to the bearing metal layer. Particles selected from a group comprising TiO₂, ZrO₂, Al2O₃, diamond have proved to be particularly suitable for this. The proportion of nanoparticles in the respective binary alloy is between 0.05 vol. %, preferably 0.5 vol. % and 5 vol. %, preferably 3 vol. %, relative to the respective silver-bismuth or copper-bismuth alloy of in sum 100 wt. % silver or copper and bismuth.

All of the details relating to value ranges in the present description are such that they also include any and all subranges. For example, the specification 1 to 10 means that all subranges are included, starting from the lower limit of 1 and the upper limit of 10, i.e. the complete subrange begins at a lower limit of 1 or more and ends at an upper limit of 10 or less, e.g. 1 to 1.7 or 3.2 to 8.1 or 5.5 to 10.

The embodiments describe possible embodiment variants of the bearing element or the lining, whereby it should be noted at this point that the invention is not restricted to the specifically shown embodiments but rather various combinations of the individual embodiments are possible and this variability lies within the ability of a person skilled in this particular field on the basis of the technical teaching of the present invention. Thus also all conceivable embodiment variants which are possible by combining individual details of the embodiment variants shown and described are also covered by the scope of protection.

The objective underlying the independent solutions according to the invention can be taken from the description.

1. Lining made from an alloy with a silver or copper base for a bearing element, wherein silver or copper form the matrix, including the impurities that are unavoidable from the production of these metals, and bismuth is contained in an amount selected from a range with a lower limit of 2 wt. % in the case of silver or 0.5 wt. % in the case of copper and an upper limit for both of 49 wt. %.

2. Lining according to claim 1, wherein it contains bismuth in an amount selected from a range with a lower limit of 10 wt. % and an upper limit of 30 wt. %.

3. Lining according to claim 1, wherein hard particles are contained in the alloy with a grain size selected from a range with a lower limit of 10 nm and an upper limit of 100 nm.

4. Lining according to claim 2, wherein the hard particles are selected from a group comprising oxides, carbides, nitrides, such as e.g. titanium dioxide, zirconium dioxide, aluminium oxide, tungsten carbide, silicium nitride and also diamond and mixtures of at least two different materials.

5. Lining according to claim 2, wherein the proportion of hard particles relative to the Ag/Bi or Cu/Bi alloy is selected from a range with a lower limit of 0.05 vol. % and an upper limit 5 vol. %.

6. Bearing element, in particular a sliding bearing, comprising a support element, a lining and a bearing metal layer arranged in between, wherein the lining is formed according to claim 1.
